(19) United States
(12) Patent Application Publication
(10) Pub. No.: US 2015/0255876 A1
(43) Pub. Date: Sep. 10, 2015

(54) SYSTEMS AND METHODS FOR ADJUSTABLE ABERRATION LENS

(71) Applicant: THE TRUSTEES OF COLUMBIA UNIVERSITY IN THE CITY OF NEW YORK, New York, NY (US)

(72) Inventor: Francesco Volpe, New York, NY (US)

(73) Assignee: THE TRUSTEES OF COLUMBIA UNIVERSITY IN THE CITY OF NEW YORK, New York, NY (US)

(21) Appl. No.: 14/577,208

(22) Filed: Dec. 19, 2014

Related U.S. Application Data
(63) Continuation of application No. PCT/US2013/048337, filed on Jun. 27, 2013.
(60) Provisional application No. 61/770,161, filed on Feb. 27, 2013.
(60) Provisional application No. 61/764,849, filed on Feb. 14, 2013.
(60) Provisional application No. 61/665,150, filed on Jun. 27, 2012.

(51) Int. Cl. H01Q 15/00; H01Q 15/08; G02B 13/14

(52) U.S. Cl. CPC H01Q 15/0086; G02B 13/14; H01Q 15/08

(57) ABSTRACT

Adjustable aberration lens for focusing a light wave in optical communication with the lens therethrough, the light wave having a plurality of frequency components including a lower frequency component and a higher frequency component, includes a metamaterial having a plurality of zones, each zone configured to shift a phase of the light wave by a phase shift amount, wherein a combined phase shift amount of the plurality of zones focuses the light wave such that the higher frequency component has a focal length greater than or equal to the lower frequency component. Methods for focusing a light wave are also provided.

### CROSS REFERENCE TO RELATED APPLICATIONS

This application is a continuation of International Application No. PCT/US2013/048337, filed on Jun. 27, 2013, which claims priority to U.S. Provisional Application No. 61/770,161, filed on Feb. 27, 2013; U.S. Provisional Application No. 61/764,849, filed on Feb. 14, 2013; and U.S. Provisional Application No. 61/665,150, filed on Jun. 27, 2012, each of which is incorporated by reference herein in its entirety.

### BACKGROUND

Millimeter waves can be directed into and out of a magnetically confined plasma. One possible application can be the detection of electron cyclotron emission (ECE) to infer the electron temperature profile. At least two properties of tokamak plasmas can be used to infer the electron temperature profile: (1) the cyclotron frequency (and harmonics) at which electrons emit ECE can be a function of the major radius Rₘₐⱼ, and (2) the electron temperature can be proportional to the radiative temperature because the tokamak plasma can be a blackbody emitter for first-harmonic ordinary mode and second-harmonic extraordinary mode. The ECE frequency distribution over Rₘₐⱼ can be determined by the strength of the toroidal magnetic field at a given Rₘₐⱼ, with corrections for Doppler and relativistic broadening. The magnetic field (and the electron cyclotron frequency) in a tokamak plasma can be roughly inversely proportional to the major radius. Electrons at smaller Rₘₐⱼ can emit ECE of higher frequency, and electrons at a larger Rₘₐⱼ can emit ECE of a lower frequency. The radiation can be spectrally analyzed by an ECE diagnostic device, which can be located on the low-field side of the tokamak.

ECE from the plasma can be reflected off an ellipsoidal mirror on the low-field side of the tokamak. The ECE can be received by a scalar horn antenna connected to a radiometer, for example a 40-channel radiometer. The mirror can have essentially the same focal length at all frequencies. The frequencies detected by the radiometer can be emitted from a range of major radii that differ by up to 0.85 m and can vary with toroidal field strength.

Examples of techniques to control chromatic aberrations include an achromatic doublet, a combination of a convergent and divergent lens of different materials with different amounts of dispersion. The focal length of each lens can be a monotonic function of frequency f, and the focal length of a doublet can be approximately quadratic in f. The focal length can match a desired focal length l at two frequencies and can be approximately matched in a range around these frequencies. Other examples include “apochromatic” triplets or “superachromatic” quadruplets of lenses, where l can take a certain value at three or four frequencies. That value can be the same to minimize chromatic aberration.

Certain techniques to control chromatic aberrations can be applied to produce the reverse chromatic aberration desired for the RCA optic to detect ECE. Applying such techniques to produce RCA can limit the degrees of freedom to two per lens (the focal length l for a certain f and the material, which can indirectly fix the dependence at other frequencies, l(f)). Applying such techniques can also limit the maximum number of lenses that can be arrayed or stacked together. Single lenses made of natural materials can be constrained to impart greater dispersion to waves with higher f (i.e., exhibit traditional chromatic aberration).

### SUMMARY

Systems and methods according to the disclosed subject matter include adjustable aberration lenses for focusing a light wave in optical communication with the lens therethrough. The light wave has a plurality of frequency components including a lower frequency component and a higher frequency component. According to one aspect of the disclosed subject matter, an adjustable aberration lens includes a metamaterial having a plurality of zones, each zone configured to shift a phase of the light wave by a phase shift amount, wherein a combined phase shift amount of the plurality of zones focuses the light wave such that the higher frequency component has a focal length greater than or equal to the lower frequency component.

In some embodiments, each zone can include one or more miniaturized-element frequency selective surfaces (MEFSSs). Each MEFSS comprises N capacitive layers alternated with N-1 inductive layers, with dielectric layers disposed therebetween. The capacitive layers each can include a sub-wavelength metallic patch. The inductive layers each can include a sub-wavelength wire grid. As such, each MEFSS can be configured to produce a frequency response of an Nth-order coupled-resonator bandpass filter.

In some embodiments, the phase shift amount can be determined by physical parameters of each MEFSS. The physical parameters of the MEFSS can include one or more of a dimension of the capacitive layers, a dimension of the inductive layers, a thickness of the dielectric layers and a material of the dielectric layers. Furthermore, the number of zones of the lens can be 7.

In some embodiments, the metamaterial can be formed using optical lithography or X-ray lithography. The metamaterial can be formed on a bendable substrate. Additionally or alternatively, the metamaterial can be formed as a separate lens element configured to be placed in optical communication with a conventional lens to adjust chromatic aberration of the conventional lens. The metamaterial can be configured to be applied as a coating to a conventional lens.

According to another aspect of the disclosed subject matter, methods of focusing a light wave include providing a metamaterial having a plurality of zones, each zone configured to shift a phase of the light wave by a phase shift amount, and focusing the light wave through the metamaterial, whereby a combined phase shift amount of the plurality of zones focuses the light wave such that the higher frequency component has a focal length greater than or equal to the lower frequency component.

In some embodiments, each zone can include one or more miniaturized-element frequency selective surfaces (MEFSSs), and the method can further include determining physical parameters of the MEFSS to obtain the phase shift amount. Each MEFSS can include N capacitive layers alternated with N-1 inductive layers, with dielectric layers disposed therebetween, and determining the physical parameters of the MEFSS can include determining one or more dimensions of the capacitive layers. Additionally or alternatively determining the physical parameters of the MEFSS can include determining one or more dimensions of the inductive layers. As a further alternative, determining the physical parameters of the MEFSS can include determining one or more dimensions of the dielectric layers. Furthermore, determining the physical parameters of the MEFSS can include determining one or more materials of the dielectric layers.

In some embodiments, the method can further include placing the metamaterial in optical communication with a conventional lens thereby adjusting chromatic aberration of the conventional lens.

Throughout the drawings, similar reference numerals and characters, unless otherwise stated, are used to denote like features, elements, components or portions of the illustrated embodiments. Moreover, while the present disclosed subject matter will now be described in detail with reference to the FIGS., it is done so in connection with the illustrative embodiments.

### BRIEF DESCRIPTION OF THE DRAWINGS

FIG. 1A shows a schematic illustrating the partitioning of exemplary unit cells (squares) of a metamaterial lens into concentric zones, FIG. 1B shows a schematic illustrating the layered structure of an exemplary MEFSS, and FIG. 1C shows a model of an exemplary MEFSS as an AC transmission line, in accordance with some embodiments of disclosed subject matter.

FIG. 2 shows a schematic setup for field intensity computations, in accordance with some embodiments of disclosed subject matter.

FIGS. 3A-3C each shows contours of normalized electric field intensity at 83.5 GHz as transmitted by (FIG. 3A) an exemplary lens with perfect transmittance, (FIG. 3B) an exemplary lens with transmittance that varies sinusoidally with radius, and (FIG. 3C) a plot of the transmittance varying with radius of the exemplary lens in FIG. 3B, in accordance with some embodiments of disclosed subject matter.

FIG. 4 shows the focal lengths of an exemplary lens at the benchmark frequencies, in accordance with some embodiments of disclosed subject matter.

FIGS. 5A-5D each shows a contour plot of (FIGS. 5A-5B) the simulated transmittance and (FIGS. 5C-5D) phase advance of electromagnetic radiation at the noted frequency through an exemplary unit cell with the parameters listed on the axes, in accordance with some embodiments of disclosed subject matter.

FIGS. 6A-6B each shows a contour plot of the goal function for exemplary unit cells when (FIG. 6A) the target functions are restricted to depend linearly on f and (FIG. 6B) the target functions are chosen as described below, in accordance with some embodiments of disclosed subject matter.

FIGS. 7A-7B each shows the dimensions of exemplary unit cells with (FIG. 7A) capacitor gap widths g for pairs of capacitive layers and (FIG. 7B) inductive widths w, in accordance with some embodiments of disclosed subject matter.

FIGS. 8A-8C shows contours of field intensity, FIGS. 8D-8F shows intensity along the central axis normal to the exemplary lens and beam radius, and FIGS. 8G-8I shows δø (defined below) and transmittance as a function of zone number for exemplary simulated lenses at the three benchmark frequencies, in accordance with some embodiments of disclosed subject matter.

FIGS. 9A-9B each shows ECE locations of selected frequencies in an exemplary D III-D tokamak relative to the beam waist regions of an exemplary metamaterial lens and an exemplary ellipsoidal mirror when (FIG. 9A) the toroidal magnetic field is −2.00 T and the lens is assumed to be positioned at a major radius Rₘₐⱼ of 3.575 m and (FIG. 9B) the toroidal magnetic field is −1.57 T and the lens is at Rₘₐⱼ=3.150 m, in accordance with some embodiments of disclosed subject matter.

FIG. 10 shows δφ (deg) and transmittance (dB) through the unit cells corresponding to zone 15 (solid lines), zone 30 (dashed lines), and zone 45 (dotted lines) of an exemplary lens in accordance with some embodiments of the disclosed subject matter.

FIG. 11 shows an exemplary method of focusing a light wave, in accordance with some embodiments of disclosed subject matter.

### DETAILED DESCRIPTION

Techniques for adjustable aberration lenses are presented. Electron Cyclotron Emission (ECE) of different frequencies can originate at different locations in non-uniformly magnetized plasmas. To observe ECE from the low-field side of the plasma, the focal length of the collecting optics can exhibit a “reverse” chromatic aberration (RCA), i.e., the focal length can increase with the frequency, in order to enhance the transverse (poloidal) resolution of an ECE diagnostic. Thus, an ECE diagnostic device can receive ECE radiation through a focusing element that exhibits RCA. By way of example and not limitation, incorporating an optic element with RCA can improve the quality of ECE detection on a tokamak, e.g., a D III-D tokamak. For example, replacing an ellipsoidal mirror with an RCA lens can enable higher spatial resolution for ECE detection of the tokamak. Additionally, an RCA lens can be moved in response to the changes in toroidal field strength to move the foci of the RCA lens.

An lens made of metamaterial can avoid the limitations of lenses made of natural materials. Metamaterial lenses can be thinner than one wavelength and can consist of hundreds of microscopic unit cells whose dimensions can be independently specified to produce more complicated focal length as a function of frequency l(f), as discussed below. Metamaterials can avoid the constraints of traditional chromatic aberration. For example, metamaterial lenses can exhibit RCA at microwave frequencies. These lenses can be made of miniaturized-element frequency-selective surfaces (MEFSSs), which can consist of alternating layers of square metal patches (capacitive layers) and wire grids (inductive layers) whose unit cells can be smaller than one wavelength, as discussed below. Altering the dimensions of the unit cells can affect the phase-advance of electromagnetic radiation transmitted through them. The unit cell parameters (and spatial phase-advance) of an MEFSS can vary as a function of distance from the transverse axis and can exhibit lens-like behavior.

By way of example and not limitation, a zoned metamaterial lens that exhibits RCA can be deployed with an 83-130 GHz ECE radiometer to detect ECE from a D III-D tokamak. The metamaterial lens can consist of a concentric array of miniaturized element phase-shifters, as discussed below. These can be reverse-engineered starting from the desired Gaussian beam waist locations and further enhanced to account for diffraction and finite-aperture effects that can tend to displace the waist. Relatively high and uniform transmittance can take place through all phase-shifters. The focal length can increase from 1.370 m to 1.967 m over the frequency range of interest, which can be desirable for low-field D III-D discharges (B=−1.57 T). Retracting the lens to receded positions can “rigidly” move the waists accordingly, which can result in matching—within a fraction of the Rayleigh length—of the Electron Cyclotron-emitting (EC-emitting) layer positions at higher fields (up to B=−2.00 T). Further, varying the lens aperture can move the waists “non-rigidly” to better match the non-rigid movement of the EC-emitting layers with the magnetic field. ECE in a D III-D tokamak can undergo relatively large variations of optimal focal length with frequency. The techniques presented herein can be employed with a wide variety of similar metamaterial lenses which can be designed for other millimeter wave diagnostics and/or devices, as will be apparent to those skilled in the art. Furthermore, the numerical methods presented herein can be applied generally to engineer any dependence of the focal length on the frequency, including zero or minimal chromatic aberration.

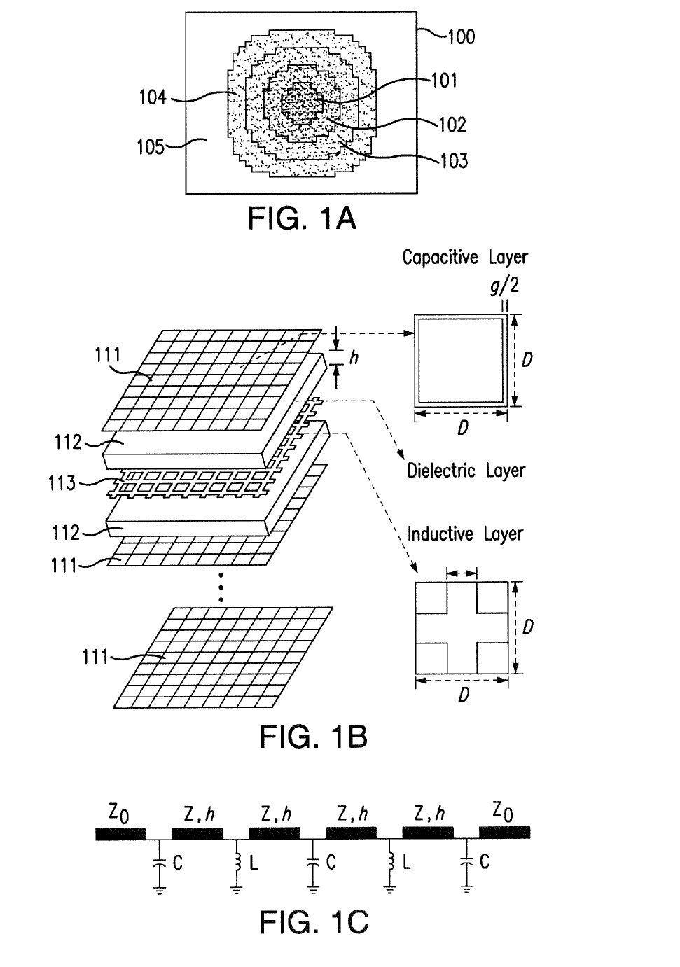

Referring to FIG. 1A, a metamaterial lens 100 can be designed by partitioning an MEFSS into a set of discrete annular zones 101-105 concentric with a perpendicular axis. Each zone can be associated with a certain phase-advance, which can be the phase-advance that its component unit cells impart to incident radiation. FIG. 1A portrays a lens with five zones 101-105 (the outermost of which extends to the edges of a rectangle). However, the lens 101 can have any suitable number of zones, e.g. 83 zones. The center zone 101 can be referred to as Zone 1. Outer zones (i.e. those with larger annular radii, e.g. zones 104-105) can impart greater phase-advances than those near the axis (e.g. zones 101-102). For example, an incident collimated beam of light that passes through a zoned MEFSS 100 can undergo a transformation in its radial phase profile and can taper to a focal point a certain distance beyond the lens. Because the design of such a unit cell can have many degrees of freedom, a geometrical configuration can have specified focal lengths for certain frequencies. For example, an appropriate geometric configuration can exhibit RCA. The appropriate unit cell parameters for each zone can be chosen based on the results of simulations of radiation passing through single unit cells.

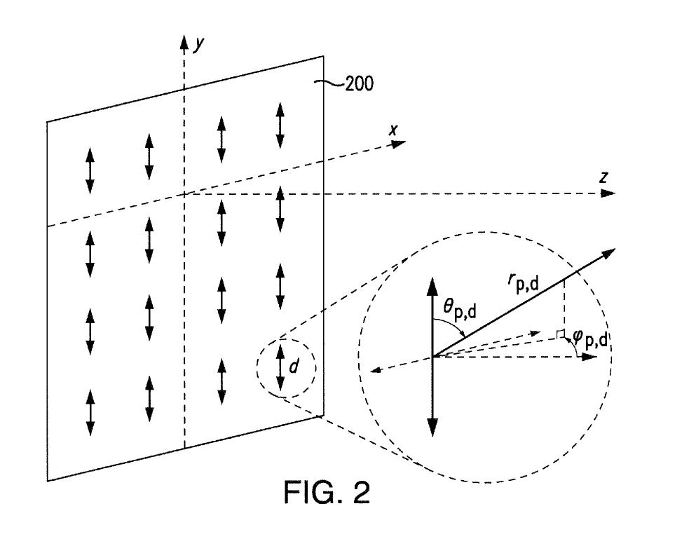

Referring to FIG. 2, an exemplary schematic setup for field intensity computations is shown. The lens 200 can be in the xy-plane. The dipoles d can have any polarization, including arbitrary polarization. For example, each dipole d can be polarized parallel to the y-axis. The electric field at a point p (in the exemplary xyz coordinate system) can be determined by computing the coherent sum of the contributions from each dipole d. Each dipole d can represent a single unit cell of the metamaterial lens 200.

In the regime of Gaussian optics, waves can be treated as a superposition of Gaussian modes (i.e., solutions to the paraxial wave equation). For waves that propagate along an axis perpendicular to the lens 200 (e.g. the z-axis), the electric field of each Gaussian mode can be of the form

$$E α exp [ - \frac{{r}^{2}}{{s ( z )}^{2}} - ikz - i Φ ( z , r , f ) + i {Φ}_{0} ] \qquad ( 1 )$$

where r is the distance from the propagation axis, z is the distance along the axis, s(z) is a characteristic transverse radius for the beam, k is the wave number, Φ₀ is an arbitrary phase offset, and Φ(z,r,f), hereafter the “phase profile,” is

$$Φ ( z , r , f ) = \frac{π f}{cR ( z , f )} {r}^{2} \qquad ( 2 )$$

where f is the frequency and R(z,f) is the radius of curvature.

The focal length l at frequency f of a lens can be defined as the distance of the beam waist of an outgoing wave of frequency f from the lens 200 for an exemplary incoming wave having a uniform phase profile (infinite R) at its point of incidence with the lens. For the purpose of defining the focal length l the outgoing wave can be modeled as a Gaussian mode with a well-defined beam waist. The lens can convert the phase profile of the incoming wave (which can be modeled as uniformly zero) to the profile Φ(l, r,f). In practice, the output can be a superposition of modes. Note that geometric optics can define the focal length as the convergence point for parallel incident rays after refraction.

The lens 200 can have a set of focal lengths l for a corresponding set of frequencies f. This set can determine the phase profile Φ(l,r,f) that the lens 200 can impart to the outgoing wave. This set can also determines the radius of curvature R(l,f) associated with the phase profile. The lens can impart a phase-advance ø to the incoming wave (which can be modeled as a plane wave with R=∞ at incidence with the lens 200) at radial distance r by a phase equal to Φ(l,r,f). The unit cells of the lens 200 can be partitioned into n concentric annular zones such that a unit cell in the nth zone (of annular radius rₙ) can impart a phase-advance equal to the desired phase profile plus an arbitrary constant: ø(n,f)=Φ(l,rₙ,f)+Φ₀.

The lens 200 can have finite aperture. Setting ø=Φ can yield the desired l if the aperture is much wider than the beam. However, the aperture may not always be much wider than the beam, e.g. when the aperture has a radius of 15 cm or less. In practice, to achieve a desired focal length, the phase-advance ø of each zone can correspond to an “adjusted” radius of curvature R_{adj}, which can be slightly greater than that of the desired output Gaussian mode, as described below.

To determine the adjusted radii of curvature, the metamaterial lens 200 can be modeled as an array of radiating electric dipoles, each of which can corresponded to a single unit cell of the MEFSS. Such a dipole array can be used to represent a lens 200 consisting of discrete phased elements. In practice, computations from such a model can agree with experimental results. Field computations using this setup can be faster than numerical solutions of electromagnetic waves propagating through a simulated metamaterial lens 200.

As with the unit cells in the metamaterial lens 200, the dipoles d in the computations can be assigned to annular zones based on their distance from the beam axis. The dipoles d in each zone can be given an amplitude and phase corresponding to a Gaussian mode (Eq. 1) evaluated at frequency f with s=9:8 cm, which can be chosen such that 99% of the beam energy can pass through an exemplary aperture, e.g. an aperture with a radius 15 cm. Φ can initially equal the phase profile Φ(l,rₙ,f), which can correspond to the desired focal length l. The “actual” focal length l_{act} of this setup can be determined by finding a point of peak field intensity along the z-axis. To determine the appropriate phase-advance ø(n,f) for the nth zone at frequency f, the radius of curvature R associated with Φ can be adjusted until l_{act} converges to l. This adjusted radius of curvature, R_{adj}, can be frequency-dependent. The phase advance of zone n at frequency f can be

$$φ ( n , f ) = \frac{π f}{{cR}_{adj} ( f )} {r}_{n}^{2} + φ o ( f ) \qquad ( 3 )$$

where ø₀(f) can be substituted for Φ₀ in Eq. 1.

The phase-advances of the unit cells can have a degree of freedom in that as long as the phase advances of each zone ø(n,f) vary appropriately relative to each other, the absolute phase-advance can be any suitable value. As such, ø(n,f) can vary by an arbitrary constant ø₀(f), which can vary with frequency and can be the same for all zones n at a given f. The relative phase advance Δø can be defined as an auxiliary quantity corresponding to the difference in phase advance of zone n with that of zone 1 (the innermost zone):

$$\begin{matrix}Δ φ ( n , f ) ≡ φ ( n , f ) - φ ( 1 , f ) \\ = \frac{π f}{{cR}_{adj} ( f )} ( {r}_{n}^{2} - {r}_{1}^{2} )\end{matrix} \qquad ( 4 )$$

With the desired relative phase-advances Δø(n,f), a set of unit cell parameters for each zone whose spatial phase-advances can match Δø(n,f) can be determined. By way of example and not limitation, a database of unit cells can be constructed with varying internal dimensions. For example, referring to FIG. 1 B, a schematic illustrating the layered structure of an exemplary MEFSS, which can consist of alternating layers of capacitive patches 111 and inductive mesh 113 separated by dielectric material 112. The parameters g and w associated with each unit cell can be defined as in the insets and as further described below. Each of these unit cells can impart a different phase advance to an oncoming wave and can exhibit a different transmittance. Furthermore, both phase advance and transmittance can vary with frequency within the same cell, and such dependencies can vary with the geometric properties.

By way of example and not limitation, each unit cell can be of 10th order with capacitive layers 111 on both ends. For purpose of illustration and not limitation, and as embodied herein, the cells can have square cross sections with 600 μm sides, and layers can separated by 509 μm of dielectric material 112. The parameters scanned for the database can be the capacitor gap g (which can be defined as twice the spacing between the edge of a capacitive patch and the unit cell border) and the inductor width w (which can be defined as the side length of the square hole in a unit cell of the wire grid). Each capacitive 111 and inductive layer 112 within a given unit cell can have the same values of g and w, respectively. Values of g can range from 80 μm to 272 μm at intervals of 2 μm. Value of w can range from 0 μm to 40 μm at intervals of 2 μm.

By way of example and not limitation, an exemplary lens can have an aperture diameter of 0.30 m. For example, this diameter can be equal to the diameter of an exemplary viewing port onto which the lens might be installed. An increase in aperture can correspond with a greater range of phase-advances from the unit cells. To accommodate this increased range, the lens order can be increased. The lens order can be defined as the number of capacitive layers 111 (or the number of inductive layers 112 plus one). From the point of view of the unit cell, adding extra layers can amount to stacking on extra spatial phase shifters. In this way, discrepancies in phase-advance between single layers can be magnified, which can allow for greater variations in phase-advance overall between lens zones. Practical considerations can limit the lens order. For example, each added layer can introduce new absorptive losses and increase fabrication costs. An exemplary lens can be a 10th-order lens. A balance can be struck between these considerations.

The phase and transmittance properties of a unit cell of given g and w can be computed in frequency-domain simulations, e.g. frequency-domain simulations using CST Microwave Studio. In each simulation, a wave packet can be launched through a single unit cell with periodic boundary conditions. Transmittance T and the difference in phase between launching and receiving ports, which can be defined as o, can be computed for certain benchmark frequencies, e.g. six benchmark frequencies: 83.5 GHz, 92.5 GHz, 101.5 GHz, 110.5 GHz, 119.5 GHz, and 129.5 GHz. For example, the benchmark frequencies can correspond to channels of a D III-D ECE radiometer. The metal in the capacitive patches 111 and wire grids 113 can be modeled as having the material properties of copper and having zero thickness. The dielectric material 112 can be modeled as isotropic and linear.

Although the phase data δø recorded by the solver for each unit cell may not contain information about precisely how many phase cycles a wave undergoes when passing from the simulated transmitter to the simulated receiver, the phase data δø can be sufficient for the purposes of designing a lens. Since δø of a unit cell can be equal to its actual phase-advance ø plus an integer multiple of 2π radians, information about the unit cell's contribution to the interference effects of the lens can be obtained.

The aforementioned simulations can be used to enhance the performance of the unit cells. Using the results of the simulations, a set of unit cells can be selected, as described below. When arranged in a zoned array, the selected unit cells can behave as a lens with a specified set of focal lengths lᵢ corresponding to the benchmark frequencies fᵢ, as specified above.

By way of example and not limitation, one approach to selecting the unit cells can be to choose a random unit cell from the database with a certain (g, w) and use that unit cell as zone 1. This zone 1 unit cell can have parameters (gₗ, wₗ). This zone 1 unit cell can impart a certain phase-advance ø(1,fᵢ) to each of the benchmark frequencies fᵢ. This phase-advance can specify the desired phase-advances ø(n,fᵢ) for each remaining zone. For example, in a metamaterial lens with 83 zones, the remaining zone numbers can be 1<n≦83, as per Eq. 4. For each n, the database can be scanned for unit cells with parameters (gₙ, wₙ) whose phase-advances are closest to the desired ø(n,fᵢ).

Note that a different choice of (g,w) from the database as the zone 1 unit cell can yield a set of unit cells that better conforms to the desired lens behavior. For example, the aforementioned selection process can be repeated with each unit cell from the database being selected as zone 1. Thus, N hypothetical lenses can be tested corresponding to N unique cells in the database. For example, the hypothetical lens that best models the desired lens behavior can then be selected as the enhanced lens prototype.

In the aforementioned process, the zone 1 unit cell can impart phase-advances ø(1,fᵢ) that conform to one of the unit cells in the database, and the unit cells in the remaining zones can have ø(n,fᵢ) that are only approximately equal to the exact ø(n,fᵢ) corresponding to ø(1,fᵢ), as in Eq. 4. Instead of choosing unit cells from the database and using their calculated phase-advances as the exact set of phase-advances ø(l,fᵢ) for zone 1, a set of strategically chosen target functions ø(l,fᵢ) can be used. This can yield lens designs with more accurate phase-advances. For example, many possible target functions can be simulated to obtain enhanced results, as described below.

To choose parameters for each zone of the lens based on the simulation data, the following algorithm can be employed:
1. A target phase-advance function øₜₗ(l,fᵢ) for zone 1 can be chosen, as described below. Also choose a target value for transmittance Tₜ, for all zones. For example, transmittance can be uniform throughout all zones, which can enhance results, as discussed below. By way of example and not limitation, Tₜ can be chosen to be 0.7.
2. A goal function G can be computed for every unit cell from the database using the formula

$$G ( g , w , {φ}_{{t}_{1}} ) = {\sum }_{i}^{ } \frac{{[ δφ ( g , w , {f}_{i} ) - {φ}_{{t}_{1}} ( 1 , {f}_{i} ) ]}^{2}}{90} + \frac{{[ T ( g , w , {f}_{i} ) - {T}_{t} ]}^{2}}{{T}_{t}} \qquad ( 5 )$$

where δø (g, w, fᵢ) is the transmitted phase for the simulated unit cell at frequency fᵢ and T(g;w; fᵢ) is its transmittance at fᵢ.
3. Since a given δø can be equivalent to δø+360°m (m ε Z) from the point of view of interference, all unit cells with this equivalence can be considered for a given zone. The goal function G(g;w; øₜₗ+360 m) for m=0; 1; 2; . . . can be computed until the sum of øₜₗ and 360°m falls more than 100° below the lowest phase advance measured of all the unit cells. For example, using CST solver, all values for δø can be computed in the 80-130 GHz band, and in practice can be less than 0°.
4. The unit cell that produces the lowest value of G can be selected.
5. The target phase-advance function øₜₗ (l,fᵢ) can specify the target phase-advance function øₜₗ (n,fᵢ) for all the remaining zones n:

φₜ_{₁}(n,fᵢ)=φₜ_{₁}(1,fᵢ)+Δφ(n,fᵢ); (6)
where the relative phase advance øₜₗ (n,fᵢ) is defined in Eq. 4. The unit cells for which G is lowest in each zone n can be chosen.
6. The unit cells selected for each zone can form a lens L₁. Let δL₁(n, fₜ) equal the phase advance of the Zone n unit cell at frequency fᵢ. Let δφₜ_{ₖ} (n, fᵢ) equal the transmittance of the Zone n unit cell at frequency fᵢ.
7. The aforementioned processes can be repeated for a number k of different target phase-advance functions δφₜ_{ₖ} (n, f₁), which can lead to a set of prototype lenses Lₖ with transmitted phases δφ_{L}_{ₖ} (n, fᵢ) and transmittances δφ_{L}_{ₖ} (n, fᵢ).
8. The relative phase advances Δφ_{L}_{ₖ} between the unit cells of each lens Lₖ can be determined:

Δφ_{L}_{ₖ}(n,fᵢ)=δφ_{L}_{ₖ}(n,fᵢ)−δφ_{L}_{ₖ}(1,fᵢ) (7)
9. For each prototype lens Lₖ, a “macro” goal function M(Lₖ) can be computed, summed over all frequencies fᵢ and all zones n:

$$M ( {L}_{k} ) = {\sum }_{i}^{ } {\sum }_{n}^{ } {W}_{n} \frac{{[ {Δφ}_{{L}_{k}} ( n , {f}_{i} ) - Δφ ( n , {f}_{i} ) ]}^{2}}{90} + {W}_{n} \frac{{[ {T}_{{L}_{k}} ( n , {f}_{i} ) - {T}_{t} ]}^{2}}{{T}_{t}} \qquad ( 8 )$$

where Δφ(n, fᵢ) is given in Eq. 4 and Wₙ is a weight function (discussed below) given by

$${W}_{n} = {r}_{n} exp ( - \frac{{r}_{n}^{2}}{{s}^{2}} ) ; \qquad ( 9 )$$

where rₙ is the annular radius of Zone n and s is the beam radius at the lens. The lens L. with the lowest M can be selected.

The weight function Wₙ in Eq. 9 can scale the goal function to reflect the relative contribution of each zone n to the coherent sum that determines the electric field amplitude at a given observation point p. This contribution can be proportional both to the number of unit cells in the nth zone (αrₙ) and to the amplitude of the field emitted by the zone's dipoles before taking transmittance into account

$$( α exp ⌊ - \begin{matrix}2 \\ n\end{matrix} / {s}^{2} ⌋ ) .$$

Note that there is no absolute distribution of phase-advances which the zones must match. Rather, the difference in phase advance between zones can be considered, which is why relative phase advances can be used in M. A large number of different target functions φₗ(n, fᵢ) can be simulated, and each of these can lead to the creation of a possible lens Lₖ. The lens L* with the lowest M can be chosen.

The aforementioned process can identify the set of unit cells from the database (denoted by L*) that best conforms to the desired phase advances for the lens. These unit cells can further be enhanced with full time-domain simulations, for example using the CST software. These additional simulations can provide fine adjustments to the dimensions of the unit cells of L* to bring their phase advances even closer to those of the target function φₗ*. For example, the inductor width w can be constrained to remain the same for every inductive layer 113 of a given unit cell. For example, pairs of capacitive layers 111 can be allowed to vary independently. The pairs of conductive layers 111 can consist of the two innermost capacitive layers, the second from the inside, etc. The lens consisting of these further enhanced unit cells can be denoted by L**.

Computations similar to those described above can be performed to compare the focal lengths of the prototype lens L** to the desired focal lengths. For example, using the dipole array in FIG. 2, dipoles d in the nth zone can be given an initial phase equal to δφL**(n, fᵢ) of the zone n unit cell at frequency fₗ. The amplitudes of the dipoles d can be multiplied by a factor equal to the square root of the transmittance of the corresponding unit cells. Focal lengths at each benchmark frequency can be computed, as described above, by identifying the point at which the coherent sum of the contributions from each dipole d to the electric field had the greatest intensity. The beam radius s(z, fᵢ), or the distance from the propagation axis at which the field amplitude falls to 1/e times its value on the axis, can also computed for a range of z values.

Referring to FIG. 1C an MEFSS can be modeled as an alternating current (AC) transmission line. For example, the lens can behave as a spatial phase shifter. That is, the lens can split the beam into parallel channels for concurrent phase steps.

Computations performed for an ideal lens can be used to demonstrate the properties of a metamaterial lens with perfect transmittance T and whose unit cells impart precisely the phase-advances prescribed by Eq. 3. Thus calculations can be based on the radiation field of an array of electric dipoles d with a zoned Gaussian amplitude profile and a phase profile determined by Eq. 3.

A simulated lens, on the other hand, can refer to a lens whose unit cells are enhanced as described above. The amplitudes associated with the different dipoles d can be Gaussian, but multiplied to the square roots of the simulated transmittances of the respective zones. Phase offsets can be determined by the phase-advances of the simulated unit cells.

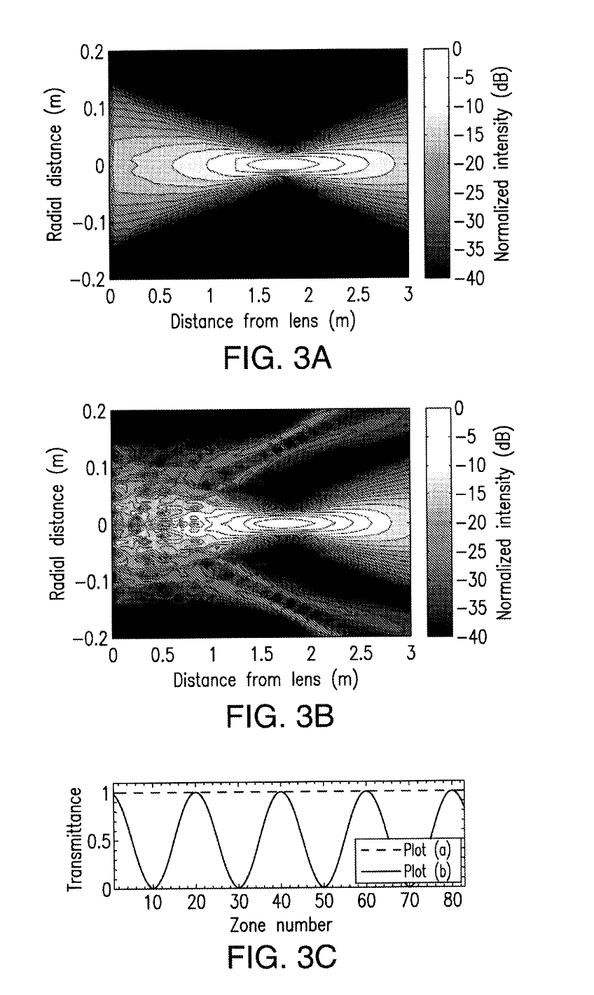

FIGS. 3A-3C shows contours of normalized electric field intensity at 83.5 GHz as transmitted by FIG. 3A an exemplary lens with perfect transmittance, FIG. 3B an exemplary lens with transmittance that varies sinusoidally with radius, and FIG. 3C a plot of the transmittance varying with radius of the exemplary lens in FIG. 3B in which each zone is approximately 1.8 mm thick. The deviation of the field in FIG. 3A from an ideal fundamental Gaussian mode can be due to the finite aperture of the simulated lens and to the discretization (into zones) of the dipole phase advance and amplitude.

The effect of a non-uniform profile of transmittance T across the lens zones can be studied by comparing ideal lenses of flat (FIG. 3A) and sinusoidally varying (FIG. 3B) T profiles. These profiles are plotted in FIG. 3C. The lens with the modulated profile can produce interference fringes in the transmitted electric field, as shown in FIG. 3B. Note that a constant target transmittance T₁ can be used in the goal functions G and M, described above.

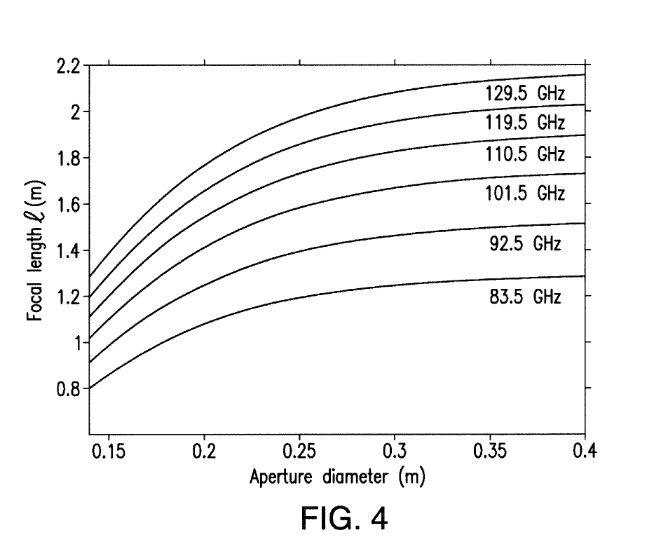

Referring to FIG. 4, focal lengths of an ideal lens at the exemplary set of benchmark frequencies is shown. For example, the beam radius at the lens can be 9.8 cm. The horizontal asymptotes can indicate what the focal lengths would be if the aperture were finite. Note that the greatest diameter for an exemplary D III-D setup can be 0.3 m. Larger apertures can be plotted as in FIG. 4 for clarity.

Ideal lens computations can show that the distance of the beam waist from the lens can be affected by the size of the aperture relative to the beam radius at the lens plane. FIG. 4 can show that increasing the lens aperture can increase the focal length l at all frequencies, as well as the spread of l with f, which can correspond to the amount of chromatic aberration.

The aforementioned effect can be advantageous if combined with a radial repositioning of the lens. For example, if the toroidal magnetic field in an exemplary D III-D tokamak is strengthened, the EC-emitting locations of the benchmark frequencies can move to smaller major radii Rₘₐⱼ and become closer together to one another. The lens can be adapted to the overall movement by moving the lens. Furthermore, the lens can adapt to the change in spacing between the locations by narrowing its aperture (e.g., with a diaphragm).

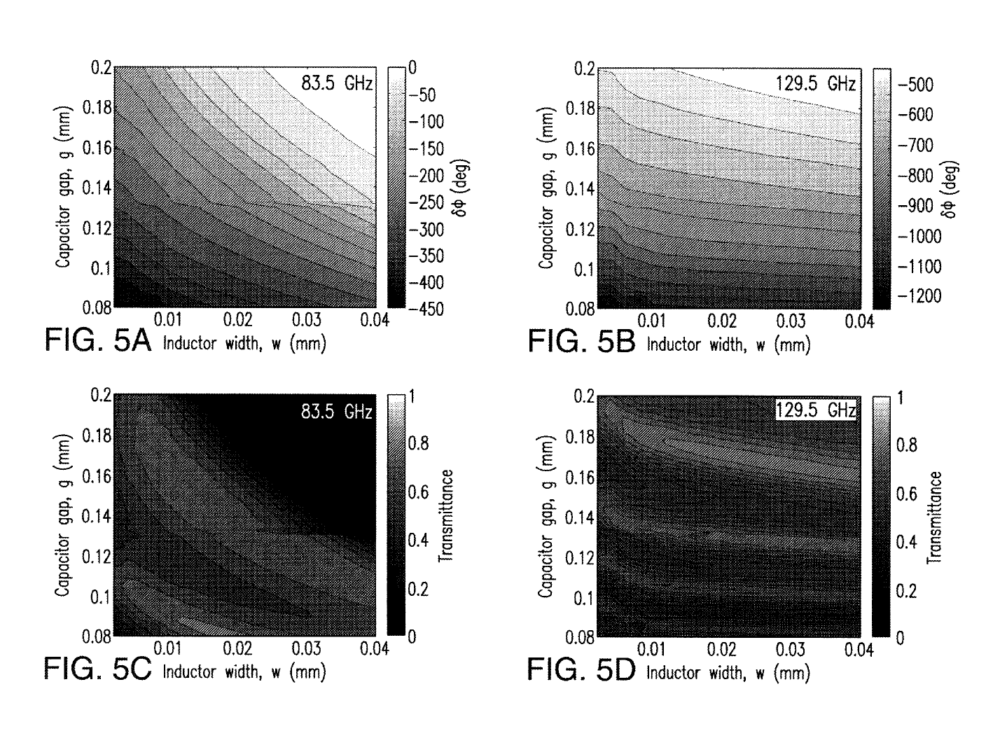

The transmittances and phase-advances associated with exemplary unit cell dimensions from an exemplary database are plotted in FIGS. 5A-5D for two exemplary benchmark frequencies. FIGS. 5A-5D shows contour plots of FIGS. 5A-5B the simulated transmittance and FIGS. 5C-5D phase advance of electromagnetic radiation at the noted frequency through an exemplary unit cell with the parameters listed on the axes, in accordance with some embodiments of disclosed subject matter.

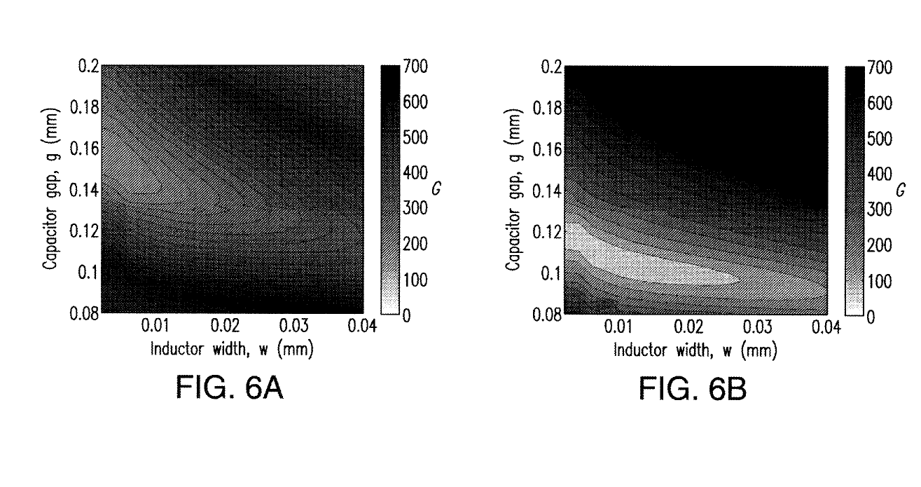

FIGS. 6A-6B shows the values of G for the database unit cells according to the enhanced target function for zone φ₁* (1, f). FIG. 6A shows contour plots of the goal function G(g, w, Φₜ*) for Zone 1 unit cells when the target functions Φₜ (for which Φₜ* corresponds to the lowest M) can be restricted to depend linearly on f. FIG. 6B shows contour plots of the goal function G when the target functions Φₗcan be chosen as described below. Note that, in this figure, values of G greater than 700 are not differentiated on the color axis. Also note that smaller values of G can be reached in FIG. 6B as compared to FIG. 6A.

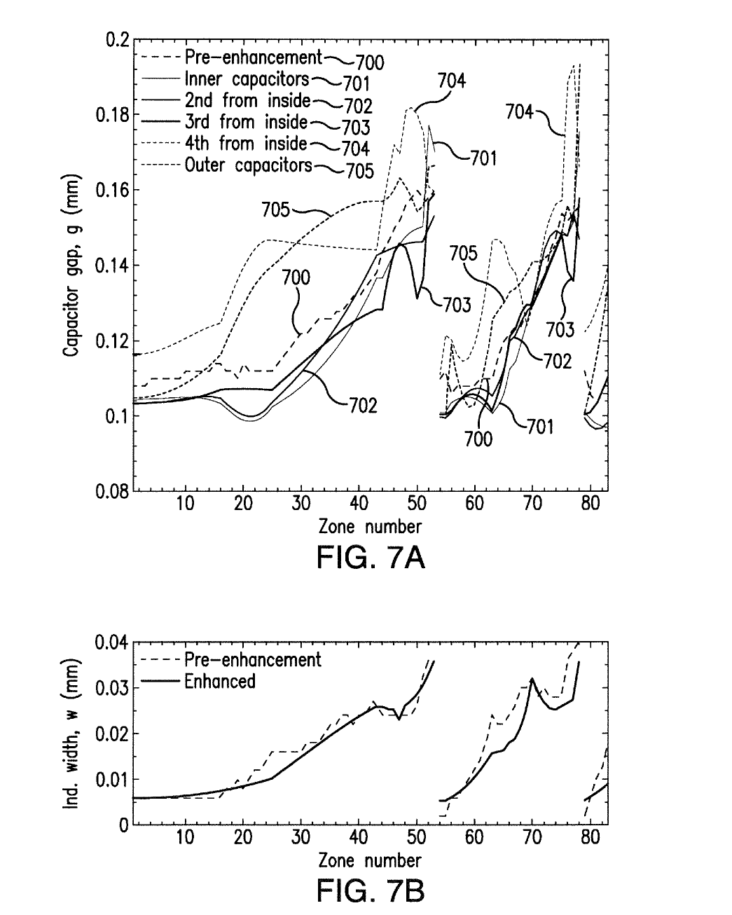

FIGS. 7A-7B shows the dimensions of exemplary unit cells for each zone as determined by the enhancement process described above. FIG. 7A shows capacitor gap widths g for exemplary pairs of capacitive layers. FIG. 7B shows inductive widths w for exemplary inductive layers. Dashed lines in both FIGS. 7A and FIG. 7B represent the dimensions selected as described above prior to the aforementioned enhancement process. The unit cell dimensions for each zone determined by the aforementioned enhancement procedure are plotted as solid lines. The transmitted phase δφ and transmittance T associated with unit cells of these dimensions can be used for the predictions of lens performance.

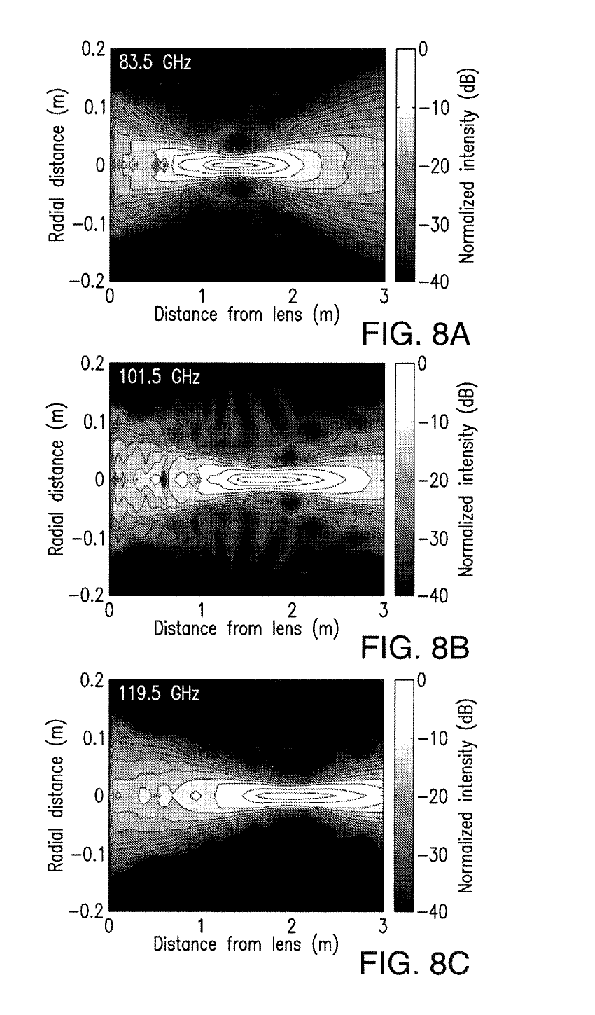

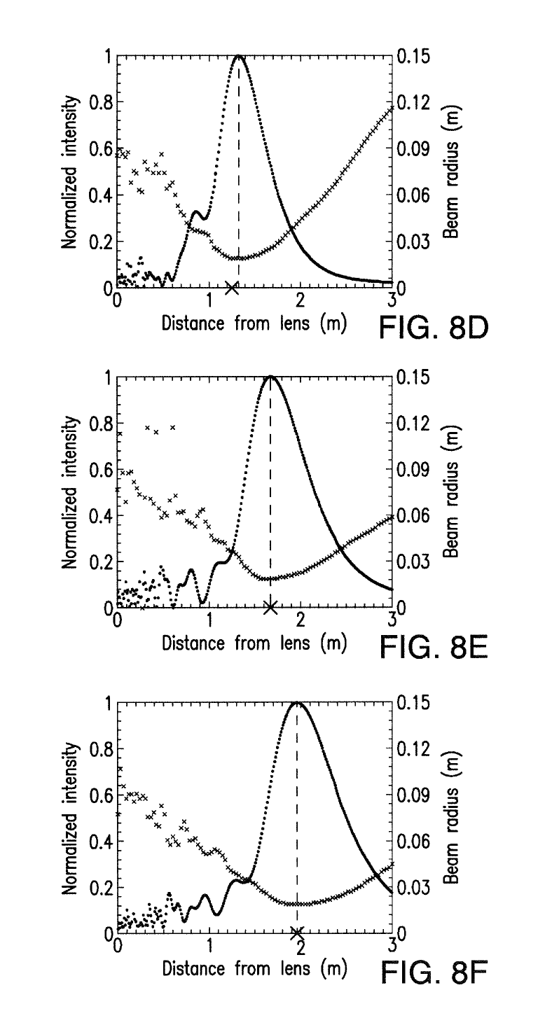

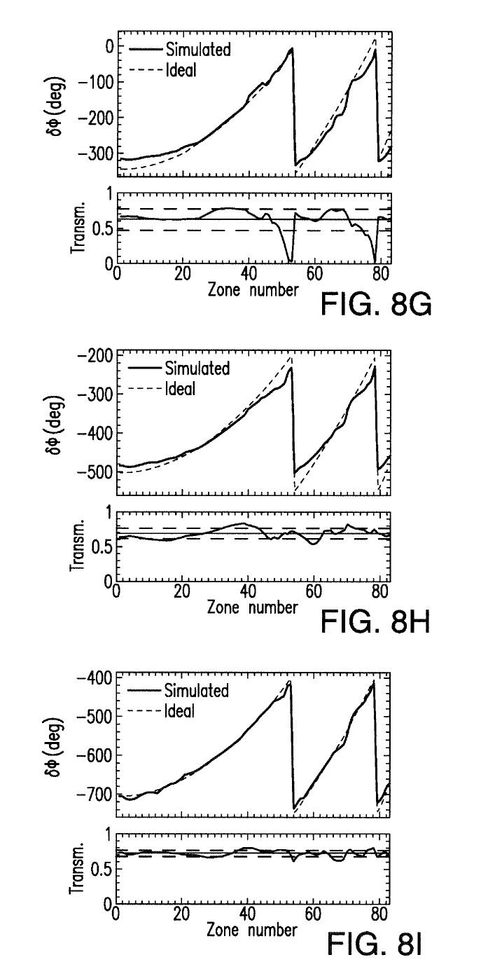

FIGS. 8A-8I shows FIGS. 8A-8C contours of field intensity, FIGS. 8D-8F intensity along the central axis normal to the exemplary lens and beam radius, and FIGS. 8G-8I δø and transmittance as a function of zone number for exemplary simulated lenses at the three exemplary benchmark frequencies, as indicated in FIGS. 8A-8C, which are applicable to the respective rows of plots. The dashed vertical lines in FIGS. 8D-8F can indicate the points of greatest field intensity (i.e., beam waist locations or focal lengths) for the simulated lenses. The X-marks on the x-axis can indicate the desired beam waist locations. Note that in the exemplary embodiment of FIG. 8, each annular zone can be three unit cells wide along the x- and y-axes of the lens, so one unit on the x-axis of (m-r) can correspond approximately with a radial distance of 0.0018 m. Note the beam waist can move forward with frequency.

The intensity contours in FIGS. 8A-8C and beam radii in FIGS. 8D-8F can closely resemble Gaussian modes, with perturbations that can be due to interference effects resulting from deviations of phase advance and transmittance from their desired values, as shown in FIGS. 8G-8I. For example, the perturbations can be observed in the near field. A general trend of RCA, in which the focal length can move away from the lens with increasing frequency, can be observed in FIGS. 8A-8F.

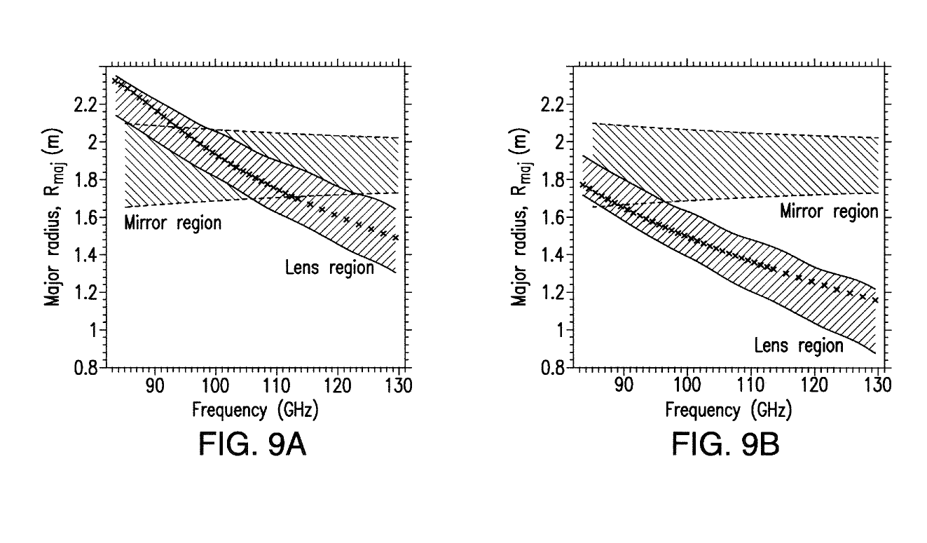

FIGS. 9A-9B shows EC-emitting locations of selected frequencies (denoted by X-marks) in an exemplary D III-D tokamak relative to the beam waist regions of an exemplary metamaterial lens (the Lens region) and an exemplary ellipsoidal mirror (the Mirror region). In FIG. 9A the toroidal magnetic field is −2.00 T and the lens is assumed to be positioned at a major radius Rₘₐⱼ of 3.575 m. In FIG. 9B the toroidal magnetic field is −1.57 T and the lens is at Rₘₐⱼ=3.150 m. The beam waist regions can be defined as the regions in which the beam radius of the Gaussian mode associated with the relevant focusing optic (e.g. lens or mirror) is within 5% of its lowest beam waist value at a given frequency. The aforementioned beam waist regions are thus bounded by the locations at which the beam radius is 5% greater than the smallest radius of the Gaussian mode associated with the corresponding focusing optic at the frequency indicated on the x-axis.

FIGS. 9A-9B demonstrates the relative accuracy of the simulated lens versus an exemplary ellipsoidal mirror as a focusing optic for EC emission in an exemplary D III-D tokamak. As the figure indicates, emission at all frequencies within the range of interest can fall within the beam waist region of the lens, both at the greatest (FIG. 9A) and least (FIG. 9B) intensities of the confining toroidal magnetic field. Note that the location of the ellipsoidal mirror can be fixed, but the metamaterial lens can be translated along the major axial direction. In this example, the lens aperture diameter can be assumed to be the 30 cm in both cases.

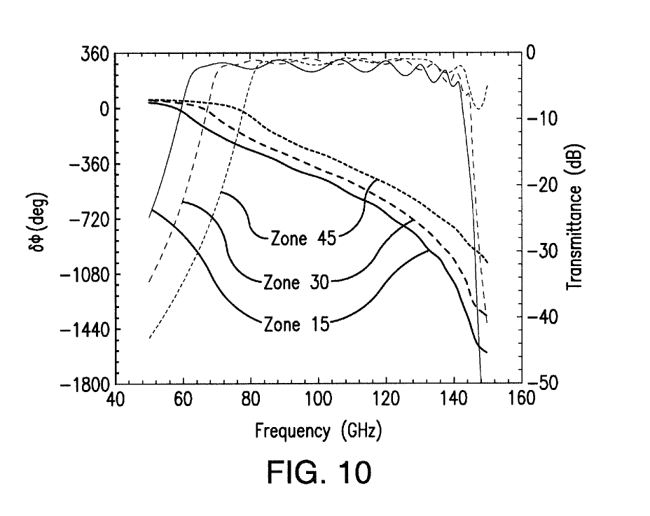

The δφ and transmittance of three exemplary unit cells of the simulated lens are illustrated in FIG. 10. For lens-like behavior, the relative phase advance Δφ can be greater for the zones that are farther from the symmetry axis. Furthermore, the rightward movement of the unit cell pass-band that accompanies the shifts in δφ(f) can be shown. This movement can illustrate ranges of arbitrary l(f) distributions that can be attained by the MEFSS-based lens. For example, the attainment of some phase profiles can be unsuitable where certain desired frequencies (for example and as embodied herein, 83-130 GHz) are excluded from the pass-band in some zones.

Note that the aforementioned experimental results used Gaussian optics rather than geometric optics. Gaussian optics can be more appropriate for the frequency and length scales of discussed above. For example, Gaussian optics can improve accuracy in the determination of the desired spatial phase-advances for the lens unit cells at these frequency and length scales. The experimental results can be corrected for the effects of a finite lens aperture diameter.

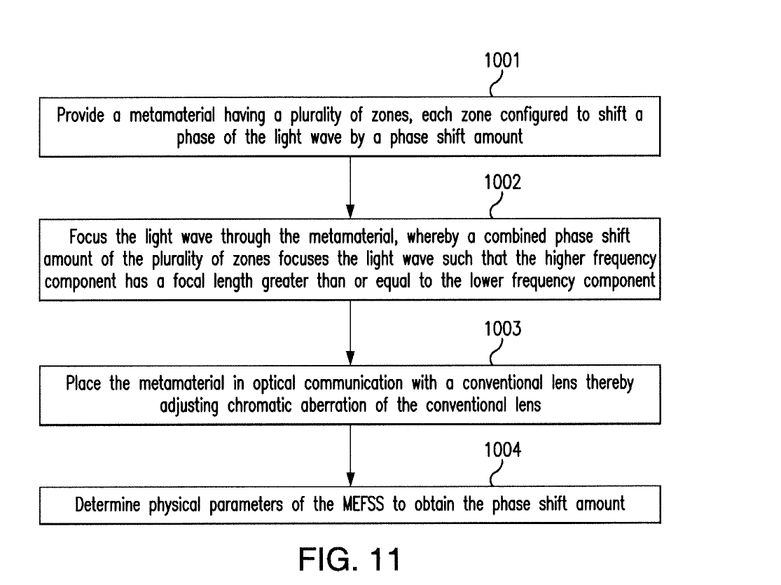

FIG. 11 shows an exemplary method of focusing a light wave, in accordance with some embodiments of disclosed subject matter. The light wave can have a plurality of frequency components including a lower frequency component and a higher frequency component. The method can include providing a metamaterial (1001). The metamaterial can have a plurality of zones. Each zone can be configured to shift a phase of the light wave by a phase shift amount. The light wave can be focused through the metamaterial (1002). A combined phase shift amount of the plurality of zones can focus the light wave such that the higher frequency component can have a focal length greater than or equal to the lower frequency component. Additionally or alternatively, the metamaterial can be placed in optical communication with a conventional lens (1003). As such, the chromatic aberration of the conventional lens can be adjusted.

In some embodiments, each zone can include one or more MEFSSs. Additionally or alternatively, the method can include determining physical parameters of the MEFSS to obtain the phase shift amount (1004). In some such embodiments, each MEFSS can have N capacitive layers alternated with N-1 inductive layers. Dielectric layers can be disposed therebetween, as described above. Dimensions of the capacitive layers, the inductive layers, or the dielectric layers can be determined, as described above. Additionally or alternatively, the materials of the dielectric layers can be determined.

As discussed above, according to the disclosed subject matter, a metamaterial lens can exhibit RCA in the 83-130 GHz range, unlike convergent lenses made of natural material. An achromatic doublet made of natural material can exhibit RCA, but such a doublet can suffer from the practical limitations of arraying several lenses of finite thickness. On the other hand, the metamaterial lenses discussed above can have a thickness comparable with or smaller than the wavelength of the electromagnetic radiation under consideration. The metamaterial lenses can be been enhanced as described above. For example, the lenses can be enhanced for possible deployment with an Electron Cyclotron Emission radiometer in an exemplary D III-D tokamak such that the beams collected at different frequencies can be correctly and simultaneously focused at their emitting locations in spite of being separated by up to 0.85 m. For example, an exemplary tokamak can have a radius R=1.66 m and the lens can be located at Rₘₐⱼ=3.15 m. Furthermore, as discussed above, translating the lens can compensate for displacements of the emitting locations caused by changes to the magnetic field.

The foregoing merely illustrates the principles of the disclosed subject matter Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within its spirit and scope.

1. A adjustable aberration lens for focusing a light wave in optical communication with the lens therethrough, the light wave having a plurality of frequency components including a lower frequency component and a higher frequency component, the lens comprising:
a metamaterial having a plurality of zones, each zone configured to shift a phase of the light wave by a phase shift amount, wherein a combined phase shift amount of the plurality of zones focuses the light wave such that the higher frequency component has a focal length greater than or equal to the lower frequency component.

2. The adjustable aberration lens of claim 1, wherein each zone comprises one or more miniaturized-element frequency selective surfaces (MEFSSs).

3. The adjustable aberration lens of claim 2, wherein each MEFSS comprises N capacitive layers alternated with N-1 inductive layers, with dielectric layers disposed therebetween.

4. The adjustable aberration lens of claim 3, wherein the capacitive layers each comprise a sub-wavelength metallic patch.

5. The adjustable aberration lens of claim 3, wherein the inductive layers each comprise a sub-wavelength wire grid.

6. The adjustable aberration lens of claim 3, wherein each MEFSS is configured to produce a frequency response of an Nth-order coupled-resonator bandpass filter.

7. The adjustable aberration lens of claim 2, wherein the phase shift amount is determined by physical parameters of each MEFSS.

8. The adjustable aberration lens of claim 8, wherein the physical parameters of the MEFSS comprise one or more of a dimension of the capacitive layers, a dimension of the inductive layers, a thickness of the dielectric layers and a material of the dielectric layers.

9. The adjustable aberration lens of claim 2, wherein the number of zones is 7.

10. The adjustable aberration lens of claim 1, wherein the metamaterial is formed using optical lithography or X-ray lithography.

11. The adjustable aberration lens of claim 1, wherein the metamaterial is formed on bendable substrate.

12. The adjustable aberration lens of claim 1, wherein the metamaterial is formed as a separate lens element configured to be placed in optical communication with a conventional lens to adjust chromatic aberration of the conventional lens.

13. The adjustable aberration lens of claim 1, wherein the metamaterial is configured to be applied as a coating to a conventional lens.

14. A method of focusing a light wave, the light wave having a plurality of frequency components including a lower frequency component and a higher frequency component, the method comprising:
providing a metamaterial having a plurality of zones, each zone configured to shift a phase of the light wave by a phase shift amount;
focusing the light wave through the metamaterial, whereby a combined phase shift amount of the plurality of zones focuses the light wave such that the higher frequency component has a focal length greater than or equal to the lower frequency component.

15. The method of claim 14, wherein the wherein each zone comprises one or more miniaturized-element frequency selective surfaces (MEFSSs), the method further comprising determining physical parameters of the MEFSS to obtain the phase shift amount.

16. The method of claim 15, wherein each MEFSS comprises N capacitive layers alternated with N-1 inductive layers, with dielectric layers disposed therebetween, and determining the physical parameters of the MEFSS includes determining one or more dimensions of the capacitive layers.

17. The method of claim 15, wherein each MEFSS comprises N capacitive layers alternated with N-1 inductive layers, with dielectric layers disposed therebetween, and determining the physical parameters of the MEFSS includes determining one or more dimensions of the inductive layers.

18. The method of claim 15, wherein each MEFSS comprises N capacitive layers alternated with N-1 inductive layers, with dielectric layers disposed therebetween, and determining the physical parameters of the MEFSS includes determining one or more dimensions of the dielectric layers.

19. The method of claim 15, wherein each MEFSS comprises N capacitive layers alternated with N-1 inductive layers, with dielectric layers disposed therebetween, and determining the physical parameters of the MEFSS includes determining one or more materials of the dielectric layers.

20. The method of claim 14, further comprising placing the metamaterial in optical communication with a conventional lens thereby adjusting chromatic aberration of the conventional lens.
